(19) United States
(12) Patent Application Publication
(10) Pub. No.: US 2007/0104846 A1
(43) Pub. Date: May 10, 2007

(54) Aseptic pudding with puree

(76) Inventor: Frank Welch, Kentwood, MI (US)

Correspondence Address: NOVARTIS;CORPORATE INTELLECTUAL PROPERTY, ONE HEALTH PLAZA 104/3, EAST HANOVER, NJ, 07936-1080, US

(21) Appl. No.: 11/528,088

(22) Filed: Sep. 27, 2006

Related U.S. Application Data
(60) Provisional application No. 60/720,833, filed on Sep. 27, 2005.

(51) Int. Cl. A23L 1/05

(52) U.S. Cl. 426/573

(57) ABSTRACT

An aseptic pudding comprising puree composition of fruit and/or vegetables, a protein component, a physical stabilizer and a chemical stabilizer.

### CROSS REFERENCE TO RELATED APPLICATIONS

The present application claims the benefit of U.S. Provisional Application 60/720,833 filed on Sep. 27, 2005, which is incorporated by reference herein.

### SPECIFICATION

As used throughout, ranges are used as a shorthand for describing each and every value that is within the range. Any value within the range can be selected as the terminus of the range. When used, the phrase “at least one of” refers to the selection of any one member individually or any combination of the members. The conjunction “and” or “or” can be used in the list of members, but the “at least one of” phrase is the controlling language. For example, at least one of A, B, and C is shorthand for A alone, B alone, C alone, A and B, B and C, A and C, or A and B and C.

A pudding is defined as a highly viscous or thickened composition. The pudding of the present invention comprises puree composition of fruit and/or vegetables, a protein component, a physical stabilizer and a chemical stabilizer. The pudding can be any pudding composition that can be aseptically processed. Generally, pudding is made from milk and starch.

The fruit and/or vegetable can be any fruit or vegetable that is desired. Fruits that can be used include, but are not limited to, apple, banana, pear, citrus, grapes, plums, berries, mango, peach, and nectarine. Vegetables that can be used include, but are not limited to, butternut squash, sweet potato, and carrot. Any combination of fruit and/or vegetable can be used.

The puree composition is defined as a macerated food component. The fruit or vegetable puree can be added to replace granulated sugar that is used to sweeten pudding. In addition to replacing the granulated sugar content, the puree can add additional flavor to the pudding. The amount of puree can be any amount greater than 0% by weight up to an amount where a pudding is still formed. In one embodiment, the amount of puree can range from greater than 0% up to about 20% by weight of the pudding. In one embodiment, the puree is present at about 10% by weight of the pudding.

The protein component is selected from dairy and soy ingredients. More specifically, the protein is selected from the group consisting of but not limited to milk protein, skim milk powder, caseinate, milk powder, milk, soy milk, whey, yogurt and combinations thereof.

The physical stabilizer is selected from colloids. More specifically, the physical stabilizer is selected from the group consisting of but not limited to hydrocolloid such as carageenan, pectin, cellulose gel, locust bean gum, gums in general.

The chemical stabilizer is a polyatomic ion. More specifically, the chemical stabilizer is selected from the group consisting of but not limited to disodium phosphate, sodium citrate, trisodium phosphate and combinations thereof.

The pudding of the present invention is prepared by first adding a chemical stabilizer using to a protein component. A physical stabilizer is then added to the mixture of chemical stabilizer and protein component. Each mixing step involves use of any traditional mixing process. In the preferred embodiment, the mixing steps involve use of a high sheer mixer. The high sheer mixer is one which is generally known in the art. The combination of physical stabilizer, chemical stabilizer and protein component are then heated to about 160 F. The combination is then homogenized using a homogenizer known to those skilled in the art. Finally, the puree is added to the homogenized composition. Any homogenizer known to those skilled in the art could be used. In the preferred embodiment, a scrape surface mixer or portable propeller mixer is used.

After the pudding is prepared, it is processed for aseptic packaging. Any aseptic processing process can be used. In one embodiment, the pudding is heated to a minimum of 135.5° C. (276° F.) and held for a minimum of 15 seconds before being cooled and filled aseptically into plastic cups.

After packaging, the pudding can be stored at room temperature without bacterial growth for an extended period of time. In one embodiment, the pudding can achieve a shelf life of at least 12 months when storage temperatures do not exceed 23.9° C. (75° F.). Additionally, the pudding can resist separation and maintain its consistency over the shelf life of the pudding. In one embodiment, the viscosity remains within 20% of the 24 hour viscosity value.

### SPECIFIC EMBODIMENTS OF THE INVENTION

The invention is further described in the following examples. The examples are merely illustrative and do not in any way limit the scope of the invention as described and claimed.

The following banana pudding can be prepared. The percentages listed are based on the total weight of the composition.

| Ingredient | Percentage by weight |
|---|---|
| Water | 72.055 |
| Sodium steroyl Lactylate | 0.18 |
| Disodium phosphate | 0.05 |
| Nonfat dry milk | 7.0 |
| Carrageenan | 0.5 |
| Modified food starch | 0.833 |
| (Thermflo from National Starch) | |
| Modified food starch | 1.667 |
| (National 1658 from National Starch) | |
| Salt | 0.215 |
| Granulated sugar | 7 |
| Banana puree | 10 |
| Banana essence | 0.5 |

The nonfat milk, sodium steroyl lactylate, disodium phosphate, carrageenan, salt, and 10% of the granulated sugar are added to hot water in a high shear mixer. This blend is then homogenized into a separate vessel. The modified food starch and the remaining granulated sugar are added, and the total solids are checked. Prior to heat processing, the banana puree and banana essence are added and the product is heated to a minimum of 135.5° C. (276° F.) for 15 seconds.

It should be appreciated that the present invention is not limited to the specific embodiments described above, but includes variations, modifications and equivalent embodiments defined by the following claims.

What is claimed is:

1. An aseptic composition comprising:
a protein component;
a physical stabilizer;
a chemical stabilizer; and
a puree composition.

2. The aseptic composition of claim 1 wherein the chemical stabilizer is a polyatomic ion.

3. The aseptic composition of claim 2 wherein the chemical stabilizer is selected from the group consisting of disodium phosphate, sodium citrate, trisodium phosphate and combinations thereof.

4. The aseptic composition of claim 1 wherein the physical stabilizer is selected from the group consisting of colloids.

5. The aseptic composition of claim 4 wherein the physical stabilizer is selected from the group consisting of carageenan, pectin, cellulose gel, locust bean gum, and gum and combination thereof.

6. The aseptic composition of claim 1 wherein the composition is in the form of a pudding.

7. The aseptic composition of claim 1 wherein the protein component is selected from milk or soy ingredient.

8. The aseptic composition of claim 1 wherein the milk-based component is selected from the group consisting of dry milk powder, milk, milk protein, skim milk powder, caseinate, milk powder, milk, soy milk, whey, yogurt and combinations thereof

9. The aseptic composition of claim 1 wherein the puree composition contains fruit.

10. A method of making an aseptic composition comprising the steps of:
adding a chemical stabilizer to a protein component;
adding a physical stabilizer to create a mixture;
heating the mixture;
homogenizing the mixture; and
adding a puree composition.
